(19) United States
(12) Patent Application Publication
(10) Pub. No.: US 2007/0081846 A1
(43) Pub. Date: Apr. 12, 2007

(54) Method and computer program product for tagging at least one page in a document containing a plurality of pages

(75) Inventor: Olivier Acher, Monts (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 11/266,332

(22) Filed: Nov. 4, 2005

(30) Foreign Application Priority Data
Oct. 11, 2005 (FR) FR 05 53083

(51) Int. Cl. B41J 11/00

(52) U.S. Cl. 400/621

(57) ABSTRACT

A method and a computer program product storing a program for tagging at least one sheet in a document comprising at least two sheets. The method and computer program product include cutting the at least one sheet by forming a cut in the at least one sheet so as to produce a tab in the at least one sheet. The cut is formed along a cut line from a point close to an edge of the at least one sheet to the edge of the at least one sheet. Further, the method and computer program product include repeating the cutting step for other sheets of the document.

### CROSS-REFERENCE TO RELATED APPLICATIONS

The present application claims priority to French Patent Application No. FR 05 53083, filed Oct. 11, 2005, hereby incorporated by reference in its entirety, and is also related to U.S. patent application Ser. No. 10/507,217, filed Sep. 16, 2004, now published as U.S. Patent Publication No. 2005/0158107.

### FIELD OF THE INVENTION

The invention relates to a method and a computer program product for tagging at least one page to distinguish it from other pages in a document. The method can be applicable in many disciplines, such as the secretarial field, for example. More generally, this method can be applicable to all printed documents where there is a need for rapid, easy tagging of one or more pages among other pages.

### DISCUSSION OF THE BACKGROUND

Several known ways exist for tagging a page, leaf, or sheet in an assembly of pages, leaves, or sheets to locate and retrieve the tagged page, leaf or sheet more rapidly and more easily.

As an example, for rapid access to certain pages of a document, it is known to provide a table of contents at the beginning of the document, and to provide index tabs which, by placing a finger on the index tab in question, allow the document to be opened directly to the part to be consulted.

However, producing index tabs may be of limited use since it may necessitate cutting certain portions of the pages of the document; and cutting may be an expensive operation.

French Patent application FR 0300911 (or International Patent Application WO 2004/069542 A1 and U.S. patent application Ser. No. 10/507,217) discloses a printer and cutter device which can produce such index tabs at low cost. However, producing such index tabs may involve cutting and removing paper from almost all of the pages of the document (and not just the pages to be tagged constituted by the pages at the start of the index). FIG. 1 shows a sheet 1 on which an index tab 2 with depth p has been cut along a line of cut i (shown as a dashed line). In this conventional approach, a portion of the sheet is removed to produce the index tab, and in order to make the index tab visible in the document, the other sheets of the document may also have a portion of depth p removed from their own areas.

Another way of rapidly retrieving a page in a document is to position bookmarks between two pages, to stick small sheets of repositionable paper of the Post-It® type, or to turn down the pages to be tagged.

The problem with such tagging means is that they may go astray (for example, the bookmarks may fall out and lose the page to be tagged, in particular when the document falls to the ground), they are not always readily available, and adding such tagging means to a document looks untidy.

It would thus be advantageous to the reader of a document who does not necessarily have access to such tagging means (index tabs, Post-It®) in a desk, to provide means which would allow the user to tag certain pages of the document so as to be able subsequently to retrieve them quickly.

### SUMMARY OF THE INVENTION

The present invention proposes a simpler way of tagging a page in a document than using known means, by using printer and cutter devices such as those disclosed in U.S. patent application Ser. No. 10/507,217, now published as US 2005/0158107, which is hereby incorporated by reference in its entirety.

The invention provides a method and a computer program product for tagging at least one sheet in a document including at least two sheets, to tag and optionally identify the at least one sheet easily. In a preferred embodiment, the invention can use a peripheral device including means for printing a sheet of paper, means for cutting the sheet of paper and means for receiving instructions. In a preferred embodiment, the method can include a step of forming at least one tab with a cut in the at least one sheet to be tagged. The cut may be a total cut or a mixed cut. The cut can be made along a line of cut starting from a point located close to one edge of the sheet and passing to the edge of the sheet. The point located close to one edge of the sheet is preferably located 2 cm or less from the edge of the sheet. The cut can be produced by means for cutting. In a preferred embodiment, the method can also include a step of repeating the preceding step for each of the sheets to be tagged. In another embodiment, the present invention provides a computer program product that stores a program which when executed by a computer causes a computer to control a peripheral device to form the tab on the sheet to be tabbed. The computer program product can store a program that causes the peripheral device to perform the above-mentioned steps.

The term “total cut” means a cut where the tab can be detached from the remainder of the sheet at the region of the cut. The term “mixed cut” means a cut where the tab remains integral with the remainder of the sheet and the user must exert a force on the tab to detach it from the remainder of the sheet. The mixed cut may be produced by a succession of total and uncut portions of the sheet along a mixed line of cut, or by a succession of total and partial cuts where only part of the thickness of the sheet is removed.

When the user needs to use the tab, the tab can be turned (by bending it) to the outside of the sheet so that the tab is visible even if other sheets are stacked on top of and beneath the sheet.

The sheets on which tabs have been produced and the other sheets of the document can then be assembled to form a total document.

In a preferred implementation, the tagging method further includes a step of forming at least one fold line starting from the point located close to one edge of the sheet and passing to the edge of the sheet, i.e. towards the outside of the sheet. The fold line can be formed by the cutter means of the device. From this fold line, the user may readily fold the tab to turn it over outside the sheet.

Advantageously, according to an embodiment of the present invention, the tagging method can further include a step of forming at least one fold line starting from one edge of the tab reaching another edge of the tab. The fold line or lines can be produced so that the tab, once folded, projects outwardly from the sheet. In another embodiment, the computer program product of the present invention can store a program that causes the peripheral device to perform the above-mentioned steps.

Advantageously, according to an embodiment of the present invention, a motif can be printed on the tab so that the motif is visible when the tab is turned outwardly from the sheet. The motif may thus identify the tab.

Advantageously, according to an embodiment, the line of cut can be formed by one or more curves or one or more straight lines. Thus, the line of cut may be formed by two straight lines forming an angle, for example of 90° between them. Other angles are possible.

Advantageously, according to an embodiment of the present invention, the line of cut can be located in an unprinted portion of the sheet. Generally, the line of cut can be located along one edge of the sheet following the length or width of the sheet.

Advantageously, the starting point for the line of cut can be located at a distance of 2 cm (centimeters) or less from the edge of the sheet.

Advantageously, according to an embodiment of the present invention, the line of cut and/or the fold line can be formed by printing the line of cut and/or the fold line on a sheet using an absorbent ink capable of penetrating deep into the sheet of paper, then by exposing the sheet to a low power laser beam emitted, as a function of received instructions, at a wavelength absorbed by the regions inked with the absorbent ink, the power of the laser being sufficient to obtain total and/or partial ablation of the paper at said regions inked with the absorbent ink.

In a preferred embodiment, the laser is one of the lasers in a matrix comprising a plurality of lasers, each laser being individually controlled. Instead of using a single laser, it is also possible to use a matrix of lasers, i.e. a matrix comprising a plurality of lasers, with each laser of the matrix being controlled individually so as to emit radiation on passing over a zone that is to be ablated. Thus, it is possible to perform the paper-cutting operations during a scan that is also used for printing on the sheet of paper. Such a matrix may comprise one or several hundreds of laser diodes. For example it may be made by assembling together a plurality of strips of diodes. The use of a matrix of lasers instead of a single laser thus may make it possible to avoid cutting taking place in a paper-handling stage subsequent to the inking stage, and consists in tracking the lines of cut on the paper using the matrix of lasers by causing the matrix of lasers to move together with the paper. It is thus possible to perform cutting in a “constant speed scanning” mode, which is the mode commonly used for the inking stage. It is thus possible to perform inking and cutting during the same paper-cutting stage. Total or partial cutting of the paper is thus obtained by one or more scans of the matrix of lasers over the sheet of paper.

In a preferred embodiment, the fold lines and/or the lines of cut on the paper can also be made by mechanical cutting part of the way (e.g., half-depth) or right through (thorough the entire thickness of the sheet), e.g. using a sharp blade.

Advantageously, according to an embodiment of the present invention, at least one sheet of the document can be printed using the printer means of the device. Printing may be carried out before or after the step of producing the line of cut or the fold line on the sheet.

### BRIEF DESCRIPTION OF THE DRAWINGS

The invention will be better understood and other advantages and features will become apparent from the following description given by way of non limiting example, made with reference to the accompanying drawings in which:

FIG. 1 shows how an index tab is formed using a conventional approach;

FIGS. 2a and 2b are in plan view, showing steps in the formation, in accordance with an embodiment of the invention, of an index tab on a page;

FIGS. 3 and 4 are in plan view, showing two other possible forms of index tabs formed in accordance with an embodiment of the invention;

FIGS. 5a and 5b are in plan view, showing steps in the formation, in accordance with an embodiment of the invention, of two bookmarks on a page; and

FIGS. 6a and 6b are in plan view, showing steps in the formation, in accordance with an embodiment of the invention, of two other bookmarks on a page.

### DESCRIPTION OF THE PREFERRED EMBODIMENTS

To illustrate the invention, there follows a description of the formation of an index tab on a sheet.

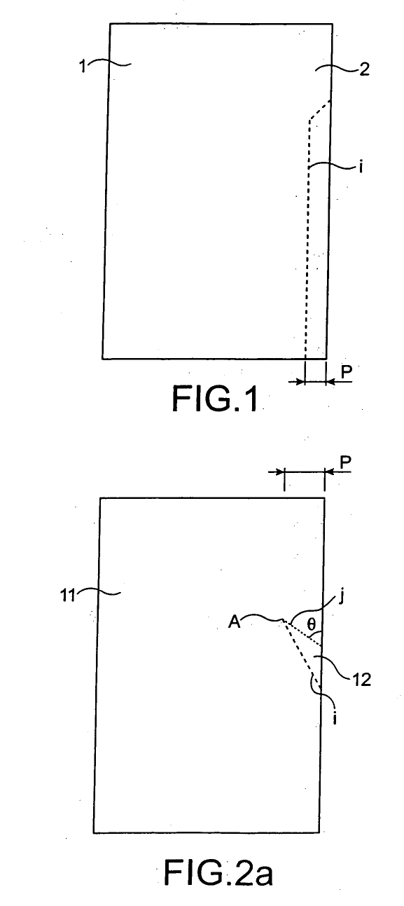

Rather than produce the index marks on the outside of the sheet as shown in the conventional approach of FIG. 1, the index tabs are formed within the sheet, close to one of the edges of the sheet. The index tab can be folded so as to turn it to the outside of the sheet. Thus, the index tabs are visible from the outside of the document when all of the sheets are assembled together.

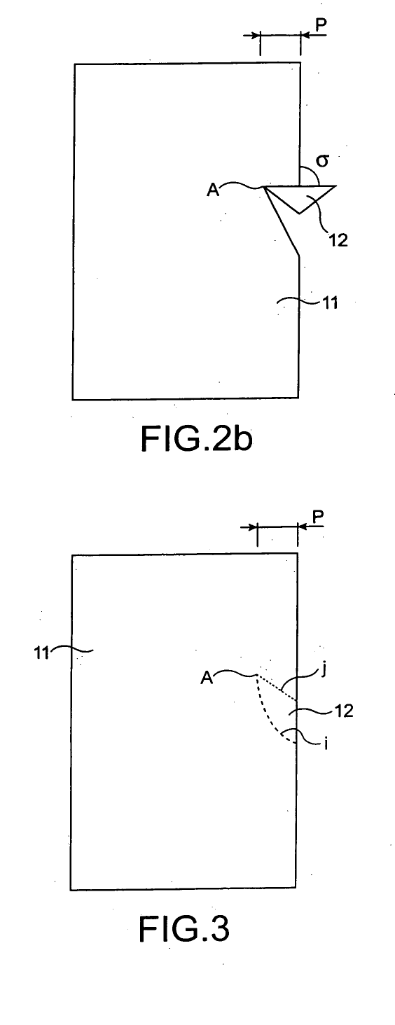

In FIG. 2a, a tab 12 is initially obtained with a line of cut i (dashed lines) extending along a line starting from a point A located at a distance p from the edge of the sheet 11 and passing in a straight line towards the outside of the sheet. Preferably, the distance p is small relative to the remainder of the dimensions of the sheet. The distance can be less than 2 cm, and preferably about 1 cm. A preferred minimum distance is at least 0.5 cm.

Subsequently, the tab 12 can be turned towards the outside of the sheet 11. Folding of the tab may optionally be facilitated by a fold line j (dotted line) which starts from point A and passes in a straight line towards the outside of the sheet (see FIG. 2a). Preferably, the angle θ between the fold line j and the edge of the sheet is an acute angle so that the tab, with a single fold, can project outside the sheet. Once folded, the tab projects beyond the edge of the sheet at an angle a (see for example FIG. 2b) and acts as an index tab. In a preferred embodiment, the angle θ is 45° so that the tab projects at an angle σ of 90° relative to the edge of the sheet 11. Other values for angles θ and σ are within the scope of the present invention. For example, θ can be between 20° and 60°, and σ can be between 40° and 135°. The sheets used may, for example, be sheets in A4 or “US legal” format (American format) routinely used in printers. However, the present invention is not limited to those size sheets and applies equally to other size sheets.

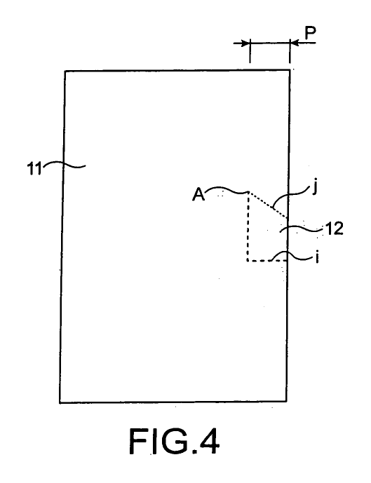

The shapes of the index tabs may also be varied. As an example, the index tabs may have a line of cut i in the shape of a curve (see for example FIG. 3) or a line of cut i in two portions: a first portion parallel to the edge of the sheet and a second portion which passes towards the outside of the sheet, for example in a straight line perpendicular to the line of the first portion ( see for example FIG. 4).

It is also possible to form bookmarks that can be detached by the user. The same method can be used to produce both index tabs and bookmarks. Instead of a total cut as in the case of index marks, the cut for a bookmark is mixed, i.e. the cut may be alternatively and successively total and non-existent or optionally total and partial, so that the user can decide to tag a page by tearing along the mixed line of cut and turning the tab towards the outside of the sheet.

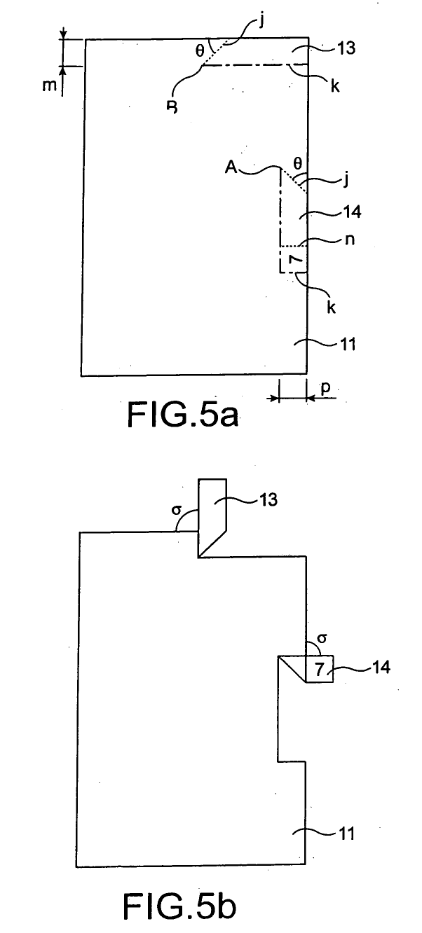

In FIG. 5a, two bookmarks are produced on one and the same sheet. A first bookmark is produced along the long side of the sheet 11: a tab 14 is obtained by a cut motif with a mixed line of cut k (line with alternating dashes and dots) starting from a point A located at a distance p from the edge of the sheet and being constituted by two portions: a first portion formed by a straight line parallel to the edge of the sheet and a second portion formed by a straight line perpendicular to the line of the first portion and passing towards the outside of the sheet 11. When the user needs the bookmark, it may be torn along the mixed line of cut k and turned outwards by being folded manually. To facilitate folding of the bookmark, a fold line j (dotted line) may also be produced in a straight line starting from point A and passing towards the outside of the sheet. The fold line j is inclined at an angle θ relative to the edge of the sheet. The comments made above for index tabs regarding the angle θ and the angle σ are also applicable to bookmarks.

The other bookmark is obtained by producing a tab 13 along the short side of the sheet. The tab has a cut motif with a mixed line of cut k which is a line parallel to the edge of the sheet and starts from a point B located at a distance m from the edge of the sheet to arrive at the outside of the sheet. A fold line j is preferably produced on the tab at an angle θ relative to the edge of the sheet.

A particular bookmark or index tab may need to be tagged by writing above a motif. As an example, a keyword or a mark which succinctly indicates what the sheet contains may be applied. In this case, this motif may also be printed during the step of forming the bookmarks and/or index tabs. It should be noted that when a printer is used that prints on one side of the sheet only, it may be advantageous to produce a second easy-fold line on the tab which goes “outside” towards the outside of the sheet, so that once folded, the motif on the tab is visible on the printed side of the sheet. In FIG. 5a, a second fold line n is shown on the tab 14 of FIG. 5a, as well as a printed motif “7”. The second fold line n is preferably positioned at an angle perpendicular to the edge of the sheet, so that once folded, the printed motif is clearly visible (FIG. 5b).

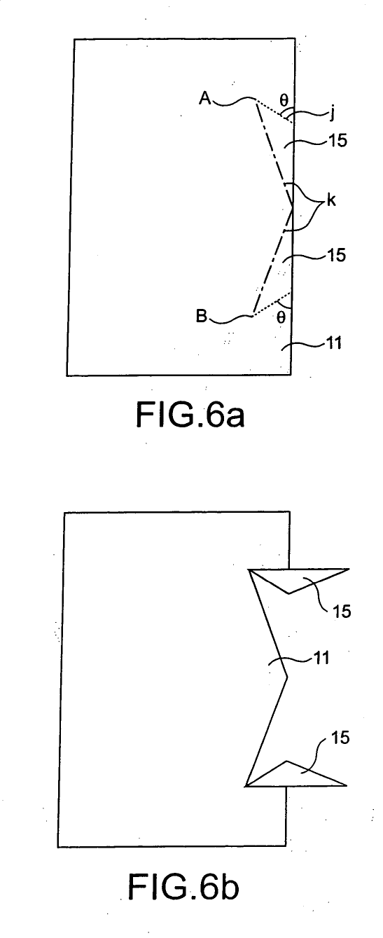

Other possible tab shapes may be used to form the bookmarks. The shapes proposed above for index tabs are also applicable to bookmarks. As an example, FIG. 6a shows two tabs 15 obtained by producing a mixed line of cut k starting from a point A (or B) and passing in a straight line towards the outside of the sheet. Fold lines j are also produced at an angle θ relative to the edge of the sheet. FIG. 6b illustrates the result once the tabs have been folded along the fold lines and turned back to the outside of the sheet.

Since the bookmarks are produced with mixed lines of cut (to allow easy tearing), the user can carry out the tab detachment step followed by the folding step. If so desired, the user may manually write indications on the bookmark so formed, or the inscription may be made in advance by the printer device.

Easily detachable tabs may be present on all or some of the pages of a document and the reader can choose which tabs are to be folded outwards, for example to make amended pages easily identifiable so that they can be retrieved more easily.

In order to produce the lines of cut and the fold lines described above, it is possible to use a printer and cutter device such as that described in U.S. patent application Ser. No. 10/507,217, now published as US 2005/0158107, which is hereby incorporated by reference. The lines of cut and fold lines may be obtained by printing the lines of cut and/or fold lines onto each sheet of paper with an absorbent ink, and by exposing each sheet to a beam of a laser emitted at a wavelength absorbed by the regions inked with absorbent ink. The laser can be a low power laser but with sufficient power to obtain total ablation (along the lines of cut) or partial ablation (along the fold lines and the mixed lines of cut) of the paper. The characteristics of the absorbent ink and the laser may be obtained from U.S. patent application Ser. No. 10/507,217, now published as US 2005/0158107, which is hereby incorporated by reference.

Preferably, word processing software or printer driver software can be used to define the positions of the lines of cut and the fold lines, their dimensions, and their arrangements on the various sheets, in order to produce sheets that can readily be consulted and index tabs or bookmarks that can be easily discerned. In particular, the document pagination and paper thickness may be used by the word processing software or software associated with the printer and cutter device to readily define the position of the lines of cut on each sheet. Thus, a computer and software may be used to properly position the printed contents of each sheet (text, drawings, illustrations, etc) with the position of the total or mixed lines of cut and any fold lines intended to form bookmarks and/or index tabs. The use of software renders easy the use of a printer and cutter device such as that disclosed in U.S. patent application Ser. No. 10/507,217, now published as US 2005/0158107, which is hereby incorporated by reference, which can produce both cuts to tag or bookmark one or more sheets and to print sheets using one and the same device.

An embodiment of the present invention may also include a computer program product suitable for being received on a storage medium and including instructions capable of being used for programming a computer in such a manner as to perform the method of the present invention. The storage medium may include, but is not limited to: any type of disk including floppy disks, optical disks, CD-ROMs, magneto-optical disks, ROMs, RAMs, EPROMs, EEPROMs, instantaneous memories (flash memories), magnetic or optical cards, or any type of medium suitable for storing electronic instructions.

The invention may also advantageously be used with a conventional program programmed in compliance with the teaching of the present specifications, as will be apparent to a person skilled in the art working in the field of computers. Appropriate coding of software can be prepared by competent programmers on the basis of the teaching in the present description, as will be apparent to a person skilled in the art working in the field of software. In particular, the computer program for cutting and printing in accordance with the present invention can be written in a variety of programming languages, including but not restricted to: C, C++, Fortran, and Basic, as will be apparent to the person skilled in the art having ordinary competence in this field. The invention may also be put into application by preparing application-specific integrated circuits or by connecting together a suitable network of conventional circuit components, as will be apparent to the person skilled in the art.

Advantageously, the word processing software or the printer driver can produce tabs which reflect the tables of contents of the document, preferably by selecting the tabs from predefined tab models included in the software.

Thus, an embodiment of the present invention also includes a computer-based product that may be hosted on a storage medium and include instructions that can be used to program a computer to perform a process in accordance with the present invention. In particular, the computer program product according to the present invention can store a program, which, when executed by a computer, causes the computer to control a device to form tabs and bookmarks as discussed above, examples of which are shown in FIGS. 2-6 of the present document. The device can be a peripheral device, such as the one disclosed in U.S. patent application Ser. No. 10/507,217, now published as US 2005/0158107, which is hereby incorporated by reference. The storage medium can include, but is not limited to, any type of disk including floppy disks, optical disks, CD-ROM, magneto-optical disks, ROMs, RAMs, EPROMs, EEPROMs, Flash Memory, Magnetic or Optical Cards, or any type of media suitable for storing electronic instructions.

This invention may also be conveniently implemented using a conventional general purpose digital computer programmed according to the teachings of the present specification, as will be apparent to those skilled in the computer art. Appropriate software coding can readily be prepared by skilled programmers based on the teachings of the present disclosure as will be apparent to those skilled in the software art. In particular, the computer program product for cut and print jobs according to the present invention can be written in a number of computer languages including but not limited to C, C++, Fortran, and Basic, as would be recognized by those of ordinary skill in the art. The invention may also be implemented by the preparation of applications specific integrated circuits or by interconnecting an appropriate network of conventional component circuits, as will be readily apparent to those skilled in the art.

1. A method of tagging at least one sheet in a document comprising at least two sheets, said method comprising the following steps:
cutting said at least one sheet by forming a cut in said at least one sheet so as to produce a tab in said at least one sheet, the cut being formed along a cut line from a point close to an edge of the at least one sheet to said edge of the at least one sheet; and
repeating the cutting step for other sheets of said document.

2. The tagging method according to claim 1, further comprising:
forming at least one first fold line in the at least one sheet, the first fold line being formed from said point located close to said edge of the sheet to said edge of the sheet.

3. The tagging method according to claim 1, further comprising:
forming at least one second fold line from an edge of the tab to another edge of the tab.

4. The tagging method according to claim 1, further comprising:
printing a motif on the tab, said motif being visible when the tab is turned outwardly from the at least one sheet.

5. The tagging method according to claim 1, wherein the cutting step is performed by forming said cut along the cut line that includes one or more curves.

6. The tagging method according to claim 1, wherein the cutting step is performed by forming said cut along the cut line located in an unprinted portion of the sheet.

7. The tagging method according to claim 1, wherein the point located close to the edge of the sheet is located at a distance of 2 cm or less from the edge of the sheet.

8. The tagging method according to claim 1, wherein the cutting step further comprises:
printing along the line of cut or the fold line on the sheet using an absorbent ink capable of penetrating deep into said sheet of paper; and
exposing said sheet of paper to a laser beam emitted, as a function of received instructions, at a wavelength absorbed by the absorbent ink, a power of the laser being sufficient to ablate the paper where the absorbent ink is printed.

9. The tagging method according to claim 8, wherein the laser beam is produced by a laser in a laser matrix comprising a plurality of lasers, each laser being configured to be controlled independently of all other lasers in the plurality of lasers.

10. The tagging method according to claim 8, wherein the power of the laser beam is sufficient to totally ablate the paper where the absorbent ink is printed.

11. The tagging method according to claim 8, wherein the power of the laser beam is sufficient to partially ablate the paper where the absorbent ink is printed.

12. The tagging method according to claim 1, wherein the forming the fold line step further comprises:
printing along the line of cut or the fold line on the sheet using an absorbent ink capable of penetrating deep into said sheet of paper; and
exposing said sheet of paper to a laser beam emitted, as a function of received instructions, at a wavelength absorbed by the absorbent ink, a power of the laser being sufficient to ablate the paper where the absorbent ink is printed.

13. The tagging method according to claim 12, wherein the laser beam is produced by a laser in a laser matrix comprising a plurality of lasers, each laser being configured to be controlled independently of all other lasers in the plurality of lasers.

14. The tagging method according to claim 12, wherein the power of the laser beam is sufficient to totally ablate the paper where the absorbent ink is printed.

15. The tagging method according to claim 12, wherein the power of the laser beam is sufficient to partially ablate the paper where the absorbent ink is printed.

16. The tagging method according to claim 1, wherein at least one sheet of the document is printed using a printer section of a peripheral device

17. The tagging method according to claim 16, wherein at least one sheet of the document is cut using a cutting section of the peripheral device.

18. The tagging method according to claim 1, wherein the forming the cut in said at least one sheet further comprises forming a total cut.

19. The tagging method according to claim 1, wherein the forming the cut in said at least one sheet further comprises forming a mixed cut.

20. The tagging method according to claim 1, wherein the cutting step is performed by forming said cut along the cut line that includes one or more straight lines.

21. A computer program product storing a program for tagging at least one sheet in a document comprising at least two sheets, the program, when executed by a computer, causes the computer to perform the following steps:
cutting said at least one sheet by forming a cut in said at least one sheet so as to produce a tab in said at least one sheet, the cut being formed along a cut line from a point close to an edge of the at least one sheet to said edge of the at least one sheet; and
repeating the cutting step for other sheets of said document.

22. The computer program product according to claim 21, further causing the computer to perform the following step:
forming at least one first fold line in the at least one sheet, the first fold line being formed from said point located close to said edge of the sheet to said edge of the sheet.

23. The computer program product according to claim 21, further causing the computer to perform the following step:
forming at least one second fold line from an edge of the tab to another edge of the tab.

24. The computer program product according to claim 21, further causing the computer to perform the following step:
printing a motif on the tab, said motif being visible when the tab is turned outwardly from the at least one sheet.

25. The computer program product according to claim 21, wherein the cutting step is performed by forming said cut along the cut line that includes one or more curves.

26. The computer program product according to claim 21, wherein the cutting step is performed by forming said cut along the cut line located in an unprinted portion of the sheet.

27. The computer program product according to claim 21, wherein the point located close to the edge of the sheet is located at a distance of 2 cm or less from the edge of the sheet.

28. The computer program product according to claim 21, wherein the cutting step further comprises:
printing along the line of cut or the fold line on the sheet using an absorbent ink capable of penetrating deep into said sheet of paper; and
exposing said sheet of paper to a laser beam emitted, as a function of received instructions, at a wavelength absorbed by the absorbent ink, a power of the laser being sufficient to ablate the paper where the absorbent ink is printed.

29. The computer program product according to claim 28, wherein the laser beam is produced by a laser in a laser matrix comprising a plurality of lasers, each laser being configured to be controlled independently of all other lasers in the plurality of lasers.

30. The computer program product according to claim 28, wherein the power of the laser beam is sufficient to totally ablate the paper where the absorbent ink is printed.

31. The computer program product according to claim 28, wherein the power of the laser beam is sufficient to partially ablate the paper where the absorbent ink is printed.

32. The computer program product according to claim 21, wherein the forming the fold line step further comprises:
printing along the line of cut or the fold line on the sheet using an absorbent ink capable of penetrating deep into said sheet of paper; and
exposing said sheet of paper to a laser beam emitted, as a function of received instructions, at a wavelength absorbed by the absorbent ink, a power of the laser being sufficient to ablate the paper where the absorbent ink is printed.

33. The computer program product according to claim 32, wherein the laser beam is produced by a laser in a laser matrix comprising a plurality of lasers, each laser being configured to be controlled independently of all other lasers in the plurality of lasers.

34. The computer program product according to claim 32, wherein the power of the laser is sufficient to totally ablate the paper where the absorbent ink is printed.

35. The computer program product according to claim 32, wherein the power of the laser is sufficient to partially ablate the paper where the absorbent ink is printed.

36. The computer program product according to claim 21, wherein at least one sheet of the document is printed using a printer section of a peripheral device

37. The computer program product according to claim 21, wherein at least one sheet of the document is cut using a cutting section of the peripheral device.

38. The computer program product according to claim 21, wherein the forming the cut in said at least one sheet further comprises forming a total cut.

39. The computer program product according to claim 21, wherein the forming the cut in said at least one sheet further comprises forming a mixed cut.

40. The computer program product according to claim 21, wherein the cutting step is performed by forming said cut along the cut line that includes one or more straight lines.
